(19) United States
(12) Patent Application Publication
(10) Pub. No.: US 2024/0079792 A1
(43) Pub. Date: Mar. 7, 2024

(54) TRANSCEIVER DEVICE INCLUDING RECONFIGURABLE INTELLIGENT SURFACE AND THE RECONFIGURABLE INTELLIGENT SURFACE

(71) Applicant: POSTECH RESEARCH AND BUSINESS DEVELOPMENT FOUNDATION, Pohang-si (KR)

(72) Inventors: Wonbin HONG, Pohang-si (KR); Youngno YOUN, Pohang-si (KR)

(73) Assignee: POSTECH RESEARCH AND BUSINESS DEVELOPMENT FOUNDATION, Pohang-si (KR)

(21) Appl. No.: 18/458,707

(22) Filed: Aug. 30, 2023

(30) Foreign Application Priority Data
Sep. 1, 2022 (KR) 10-2022-0111021
Jun. 13, 2023 (KR) 10-2023-0075579
Aug. 16, 2023 (KR) 10-2023-0107007

(51) Int. Cl. H01Q 15/14; H01Q 1/24; H01Q 3/46

(52) U.S. Cl. CPC H01Q 15/148; H01Q 1/246; H01Q 3/46

(57) ABSTRACT

A reconfigurable intelligent surface is provided. The reconfigurable intelligent surface includes a plurality of unit cells arranged in a first direction and a second direction perpendicular to the first direction, each of the plurality of unit cells including a first electrode, a liquid crystal layer, and a second electrode, a plurality of first conductive lines electrically connecting to each other first electrodes arranged in the first direction from among the first electrodes included in the plurality of unit cells, and a plurality of second conductive lines electrically connecting to each other second electrodes arranged in the second direction from among the second electrodes included in the plurality of unit cells, wherein a wave incident on the reconfigurable intelligent surface is steered in a certain direction based on an electrical signal applied to the plurality of unit cells.

### CROSS-REFERENCE TO RELATED APPLICATION

This application is based on and claims priority under 35 U.S.C. § 119 to Korean Patent Application Nos 10-2022-0111021, filed on Sep. 1, 2022, and 10-2023-0075579, filed on Jun. 13, 2023, and 10-2023-0107007, filed on Aug. 16, 2023, in the Korean Intellectual Property Office, the disclosures of which are incorporated by reference herein in their entirety.

### BACKGROUND

### 1. Field

The disclosure relates to transceiver devices including reconfigurable intelligent surfaces and the reconfigurable intelligent surfaces, and more particularly, to reconfigurable intelligent surfaces capable of performing beam steering in various directions.

This study was supported by the Samsung Future Technology Development Project (Task number: SRFC-TE2103-01).

### 2. Description of the Related Art

Recently, mobile communication requires high reliability and high information transmission rate for services such as virtual/augmented reality and movie download. However, in a wireless environment, the strength of a signal received from a base station may be lowered due to an obstacle such as a wall, and thus, the reliability and information transmission rate of a cellular network may be rapidly lowered.

In order to solve this problem, a method of installing additional base stations and repeaters has been used, but this method is not efficient because of the high installation cost and limited installation space. In order to improve the wireless communication performance in a wireless environment, a reconfigurable intelligent surface, which has less restrictions regarding an installation place and is inexpensive, is attracting attention.

A reconfigurable intelligent surface is a meta surface including elements controllable by software, and may adjust the phase of a reflected radio wave and form a desired beam through phase control of the reflected wave.

### SUMMARY

The disclosure provides a reconfigurable intelligent surface having a simple structure and thus being capable of performing beam steering in various directions.

Additional aspects will be set forth in part in the description which follows and, in part, will be apparent from the description, or may be learned by practice of the presented embodiments of the disclosure.

A reconfigurable intelligent surface according to an embodiment includes a plurality of unit cells arranged in a first direction and a second direction perpendicular to the first direction, each of the plurality of unit cells including a first electrode, a liquid crystal layer, and a second electrode, a plurality of first conductive lines electrically connecting first electrodes arranged in the first direction from among the first electrodes included in the plurality of unit cells, and a plurality of second conductive lines electrically connecting second electrodes arranged in the second direction from among the second electrodes included in the plurality of unit cells, wherein a wave incident on the reconfigurable intelligent surface is steered in a certain direction based on an electrical signal applied to the plurality of unit cells.

A cross-sectional size of the second electrode may be equal to or greater than a cross-sectional size of the first electrode.

An outer circumferential surface of at least one of the first electrode and the second electrode may include a curve.

At least one of the first electrode and the second electrode may have a cross-section of at least one of a polygonal shape, an elliptical shape, and a circular shape.

The first electrode may be entirely disposed to overlap the second electrode in a thickness direction of the liquid crystal layer.

Lengths of the first electrode and the second electrode may be less than or equal to ½ of a wavelength of the wave.

A distance between second electrodes included in adjacently arranged unit cells among the plurality of unit cells may be less than or equal to ¼ of a wavelength of the wave.

The plurality of first conductive lines may be arranged on the same plane as the first electrodes included in the plurality of unit cells.

At least one of the plurality of first conductive lines may include a plurality of first sub conductive lines spaced apart from each other in the first direction and connecting two unit cells arranged adjacently in the first direction.

Widths and lengths of the plurality of first sub conductive lines may be less than a width and a length of the first electrode, respectively.

The reconfigurable intelligent surface may further include a reflective layer spaced apart from the plurality of unit cells and reflecting waves incident from the plurality of unit cells to the plurality of unit cells.

The reflective layer may include a conductive material.

The reflective layer may be grounded.

The reconfigurable intelligent surface may further include a substrate disposed between the second electrode and the reflective layer.

A thickness of the substrate may be less than a wavelength of the wave.

A thickness of the liquid crystal layer may be less than a wavelength of the wave.

When a bias voltage is applied to the first electrodes included in the plurality of unit cells and the second electrodes included in the plurality of unit cells are grounded, the wave may be steered on a plane including the second direction.

When the first electrodes included in the plurality of unit cells are grounded and a bias voltage is applied to the second electrodes included in the plurality of unit cells, the wave may be steered on a plane including the first direction.

When a bias voltage is applied to the first electrodes and the second electrodes such that the same voltage is applied to unit cells arranged in a third direction crossing both the first direction and the second direction from among the plurality of unit cells, the wave may be steered on a plane including the fourth direction perpendicular to the third direction.

The wave may be within a millimeter wave band.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is an exploded perspective view illustrating a reconfigurable intelligent surface according to an embodiment;

FIG. 2 is a cross-sectional view of a unit cell included in the reconfigurable intelligent surface of FIG. 1;

FIG. 3 is a block diagram illustrating an antenna device including a reconfigurable intelligent surface according to an embodiment;

FIG. 4 is a diagram illustrating a communication system to which a reconfigurable intelligent surface according to an embodiment is applied;

FIG. 5 is a block diagram of a base station according to an embodiment;

FIG. 6 is a block diagram of a transceiver device according to an embodiment;

FIG. 7 is a reference diagram for explaining a method of steering a beam via the reconfigurable intelligent surface, according to a first embodiment;

FIG. 8 is a reference diagram for explaining a method of steering a beam via the reconfigurable intelligent surface, according to a second embodiment;

FIG. 9A is a reference diagram for explaining a method of steering a beam via the reconfigurable intelligent surface, according to a third embodiment;

FIG. 9B is a diagram showing an example of a voltage distribution of a unit cell in the reconfigurable intelligent surface according to an embodiment;

FIG. 10 is a result showing a phase shift according to an operating frequency of a unit cell included in the reconfigurable intelligent surface according to an embodiment;

FIG. 11 is a graph showing reflection loss according to an operating frequency of a unit cell according to an embodiment;

FIG. 12A shows a profile of a bias voltage applied to a first electrode row of the reconfigurable intelligent surface according to an embodiment;

FIG. 12B shows a result of measuring a reflection gain of the reconfigurable intelligent surface based on the bias voltage profile of FIG. 12A;

FIG. 13 is a diagram illustrating a reconfigurable intelligent surface according to another embodiment; and

FIG. 14 is a diagram illustrating a reconfigurable intelligent surface according to another embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

The description of the following embodiments should not be construed as limiting the scope of claims, and what can be easily inferred by a person skilled in the art should be construed as belonging to the scope of the embodiments. Hereinafter, embodiments for illustrative purposes only will be described in detail with reference to the accompanying drawings.

Hereinafter, embodiments may be described in detail with reference to the accompanying drawings. In the following drawings, the same reference numerals denote the same elements, and the size of each element in the drawings may be exaggerated for clarity and convenience of description. On the other hand, the embodiments described below are merely illustrative, and various modifications are possible from these embodiments.

Hereinafter, what is described as “above” or “on” may include not only what is directly above, below, left, and right in contact, but also what is above, below, left, and right in non-contact. An expression used in the singular may encompass the expression in the plural, unless it has a clearly different meaning in the context. In addition, when a portion may “include” a certain element, the portion may further include another element instead of excluding the other element, unless otherwise stated.

The use of the term “the” and similar denoting terms may correspond to both singular and plural. Unless the order of operations included in a method is explicitly stated or stated to the contrary, these operations may be performed in any suitable order, and are not necessarily limited to the order described.

Alternatively, terms, such as “unit”, “-er/or”, and “module”, described in the specification mean a unit that processes at least one function or operation, which may be implemented as hardware or software or a combination of hardware and software.

Connections of lines or connecting members between elements shown in the drawings are examples of functional connections and/or physical or circuit connections, which can be replaced in actual apparatuses or additional various functional connections, physical connections, or as circuit connections.

Expressions, such as “at least one” preceding a list of elements limit the entire list of elements, not individual elements of the list. For example, an expression, such as “at least one of A, B, and C” or “at least one selected from the group consisting of A, B, and C” means only A, only B, only C, or a combination of two or more of A, B, and C, such as ABC, AB, BC, and AC.

In a case in which “about” or “substantially” is used in reference to a numerical value, the related numerical value is to be construed to include manufacturing or operating variations (e.g., ±10%) around the stated numerical value. Alternatively, when the expressions “in general” and “substantially” are used in reference to geometric shapes, it may be intended that geometrical precision is not required and latitude for the shapes is within the scope of the present embodiment. Alternatively, regardless of whether the numerical values or shapes are limited to “about” or “substantially”, such values and shapes are to be construed as including manufacturing or operating variations (e.g., ±10%) around the stated numerical values.

While such terms as “first”, “second”, etc., may be used to describe various elements, such elements must not be limited to the above terms. The above terms may be used only to distinguish one element from another.

The use of all examples and exemplary terms is simply for explaining technical ideas in detail, and the scope is not limited due to these examples or exemplary terms unless limited by the claims.

Hereinafter, with reference to the accompanying drawings, it may be described in detail only by way of example.

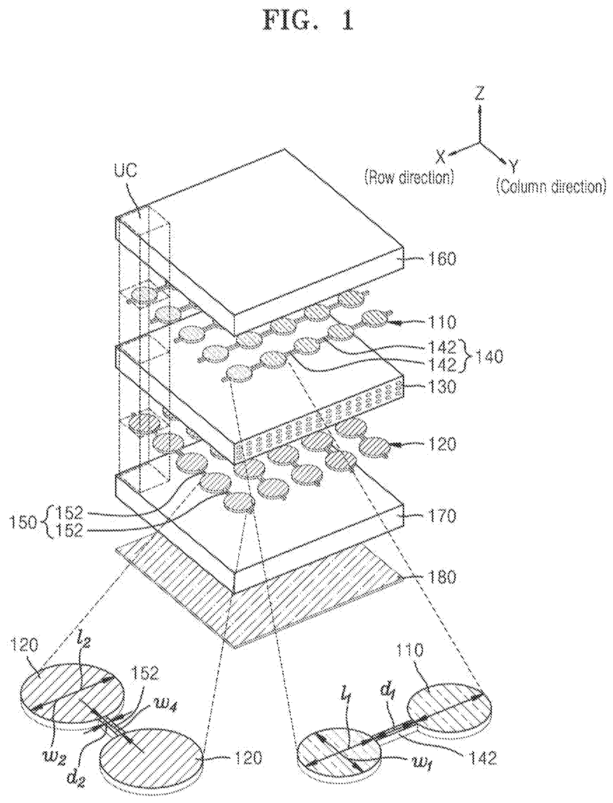

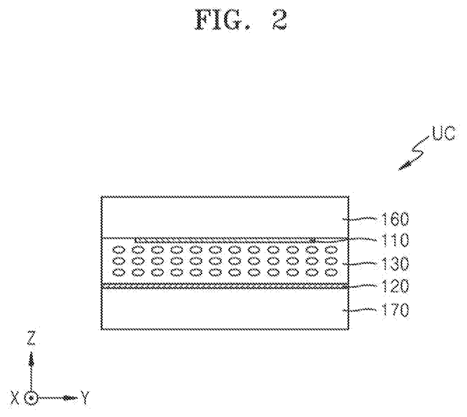

FIG. 1 is an exploded perspective view illustrating a reconfigurable intelligent surface 100 according to an embodiment, and FIG. 2 is a cross-sectional view of a unit cell UC included in the reconfigurable intelligent surface 100 of FIG. 1.

The reconfigurable intelligent surface 100 according to an embodiment may steer an incident wave in a certain direction. The wave steered by the reconfigurable intelligent surface 100 according to an embodiment may be an electromagnetic wave in a radio frequency band. For example, the reconfigurable intelligent surface 100 may steer a radio signal in a millimeter wave (hereinafter, referred to as ‘mmWave’) band. For example, the mmWave band may include 5G signals.

Referring to FIGS. 1 and 2, the reconfigurable intelligent surface 100 according to an embodiment may include a plurality of unit cells UC arranged in two dimensions. The plurality of unit cells UC may be arranged in a matrix type. For example, the plurality of unit cells UC may be spaced apart in a first direction (e.g., an X-axis direction or a row direction) and a second direction (e.g., a Y-axis direction or a column direction). The second direction may be perpendicular to the first direction. However, the embodiment is not limited thereto. The second direction may be a direction that is not perpendicular to and crosses the first direction. Although FIG. 1 illustrates a structure in which the plurality of unit cells UC are arranged in a 5×5 array, the number and arrangement of unit cells UC are not limited.

Each of the plurality of unit cells UC may include a first electrode 110, a second electrode 120 spaced apart from the first electrode 110, and a liquid crystal layer 130 disposed between the first electrode 110 and the second electrode 120.

The first electrode 110 may have a patch shape with a cross-section greater than a thickness. An outer circumferential surface of the first electrode 110 may include a curve. For example, the first electrode 110 may have a circular or elliptical cross-section. However, the embodiment is not limited thereto. The first electrode 110 may have a polygonal shape, such as a quadrangle or a hexagon. Alternatively, the outer circumferential surface of the first electrode 110 may include a combination of a curve and a straight line.

The first electrodes 110 included in the plurality of unit cells UC may be spaced apart from each other. The first electrodes 110 may be arranged at certain distances apart from one another, and a distance d₁ may be adjusted according to the installation location of the reconfigurable intelligent surface 100 and the type of wave to be converted. The distance d₁ between the first electrodes 110 may be less than the wavelength of a wave converted by the reconfigurable intelligent surface 100. For example, the distance d₁ between the first electrodes 110 may be ½ or less or ¼ or less of the wavelength of an operating wave.

The sizes of the first electrodes 110 included in the reconfigurable intelligent surface 100 may be the same, but are not limited thereto. The sizes of the first electrodes 110 may vary from location to location depending on the use of the reconfigurable intelligent surface 100. A width w₁ and a length l₁ of the first electrode 110 may be less than the wavelength of a radio wave converted by the reconfigurable intelligent surface 100. For example, the width w₁ and the length l₁ of the first electrode 110 may be ½ or less of the wavelength of a wave. Here, the width w₁ and the length l₁ of the first electrode 110 may be defined as the longest width and longest length of the first electrode 110. However, the embodiment is not limited thereto. The width w₁ and the length l₁ of the first electrode 110 may be defined as an average width and an average length of the first electrode 110.

The first electrode 110 may include a conductive material. For example, the first electrode 110 may include a metal having high electrical conductivity, such as copper.

The unit cell UC may further include a second electrode 120 spaced apart from the first electrode 110. The second electrode 120 may have a patch shape with a cross-section greater than a thickness. An outer circumferential surface of the second electrode 120 may include a curve. For example, the cross-section of the second electrode 120 may be circular or elliptical. However, the embodiment is not limited thereto. The second electrode 120 may have a polygonal shape, such as a quadrangle or a hexagon. Alternatively, the outer circumferential surface of the second electrode 120 may include a combination of a curve and a straight line.

The second electrodes 120 included in the plurality of unit cells UC may be spaced apart from each other. The second electrodes 120 may be arranged at certain distances apart from one another, and a distance d₂ may be adjusted according to the installation location of the reconfigurable intelligent surface 100 and the type of wave to be converted. The distance d₂ between the second electrodes 120 may be less than the wavelength of a wave converted by the reconfigurable intelligent surface 100. For example, the distance d₂ between the second electrodes 120 may be ½ or less or ¼ or less of the wavelength of an operating wave.

The sizes of the second electrodes 120 included in the reconfigurable intelligent surface 100 may be the same, but are not limited thereto. The sizes of the second electrodes 120 may vary from location to location depending on the use of the reconfigurable intelligent surface 100. A width w₂ and a length l₂ of the second electrode 120 may be less than the wavelength of a radio wave converted by the reconfigurable intelligent surface 100. For example, the width w₂ and the length l₂ of the first electrode 110 may be ½ or less or ¼ or less of the wavelength of a wave. Here, the width w₂ and the length l₂ of the second electrode 120 may be defined as the longest width and longest length of the second electrode 120. However, the embodiment is not limited thereto. The width w₂ and length l₂ of the second electrode 120 may be the average width and average length of the second electrode 120.

The second electrode 120 may include a conductive material. For example, the second electrode 120 may include a metal having high electrical conductivity, such as copper.

In the same unit cell UC, the first electrode 110 and the second electrode 120 may overlap each other in a thickness direction of the liquid crystal layer 130. For example, in the same unit cell UC, the entire first electrode 110 may be disposed to overlap the second electrode 120 in the thickness direction of the liquid crystal layer 130. The cross-sectional size of the first electrode 110 may be less than or equal to the cross-sectional size of the second electrode 120. Because the cross-sectional size of the first electrode 110 is less than or equal to the cross-sectional size of the second electrode 120, reflection loss of the reconfigurable intelligent surface 100 may be reduced. In order to drastically reduce reflection loss, the cross-sectional size of the first electrode 110 may be less than the cross-sectional size of the second electrode 120. A difference between the width w₁ of the first electrode 110 and the width w₂ of the second electrode 120 may be about ⅛ or less of an operating wavelength. Alternatively, a difference between the length l₁ of the first electrode 110 and the length l₂ of the second electrode 120 may be about ⅛ or less of the operating wavelength.

In order to maximize an overlapping area between the first electrode 110 and the second electrode 120 in the thickness direction of the liquid crystal layer 130, the first electrode 110 and the second electrode 120 may have the same shape. For example, cross-sections of the first electrode 110 and the second electrode 120 may be circular. As a result, inhomogeneity of the liquid crystal layer 130 may be reduced due to the unevenly applied bias voltage.

Each of the plurality of unit cells UC may further include a liquid crystal layer 130 disposed between the first electrode 110 and the second electrode 120. The thickness of the liquid crystal layer 130 may be less than the operating wavelength. For example, the thickness of the liquid crystal layer 130 may be ½ or less or ¼ or less of the operating wavelength. The liquid crystal layer 130 may include a plurality of liquid crystal molecules of which orientation is changed by voltages applied to the first electrode 110 and the second electrode 120. The plurality of liquid crystal molecules may be initially arranged in a direction in which the major axis direction is parallel to one direction, for example, to the surface of the second electrode 120 [symbol] ).

The liquid crystal molecules may be molecules having a positive type of dielectric anisotropy, but are not limited thereto. When a voltage is applied to each of the first electrode 110 and the second electrode 120, an electric field (E-field) may be generated in the liquid crystal layer 130 between the first electrode 110 and the second electrode 120. Depending on the strength of the electric field, that is, the voltage difference between the applied voltages, the liquid crystal molecules may be rotated in an orientation parallel to the electric field.

Using this phenomenon, phase modulation of an incident wave may be caused. As the major axis orientations of the liquid crystal molecules are rotated according to the electric field formed between the first electrode 110 and the second electrode 120, the reconfigurable intelligent surface 100 may form an electric prism to steer a wave in a certain direction.

The liquid crystal layer 130 is relatively inexpensive and may prevent an increase in reflection loss for waves even when the operating frequency is high. In addition, the dielectric constant of the liquid crystal layer 130 is changed according to an applied electric field, and thus, wave steering characteristics may be improved.

The liquid crystal layers 130 included in the plurality of unit cells UC may be formed as one layer in the reconfigurable intelligent surface 100. However, the embodiment is not limited thereto. However, liquid crystal layers may be grouped to form one layer, and the grouped liquid crystal layers may be separated by spacers (not shown).

Liquid crystal molecules of the liquid crystal layer 130 included in each unit cell UC may be rearranged according to an applied voltage, and thus, the dielectric constant of the liquid crystal layer 130 may change. The dielectric constant of the liquid crystal layer 130 according to an embodiment may vary according to a major axis direction of the liquid crystal molecules. For example, when the major axis direction of the liquid crystal molecules is aligned in parallel with the surface of the second electrode 120, the dielectric constant of the liquid crystal layer 130 may be the lowest. In addition, when the major axis direction of the liquid crystal molecules is aligned perpendicular to the surface of the second electrode 120, the dielectric constant of the liquid crystal layer 130 may be the highest. The alignment of the liquid crystal molecules described above may be controlled by voltages applied to the first electrode 110 and the second electrode 120. The dielectric constant of the liquid crystal layer 130 according to an embodiment may vary from about 2 to about 4 or from about 2 to about 3.5.

The reconfigurable intelligent surface 100 may further include a plurality of first conductive lines 140 electrically connecting first electrodes 110 arranged in the first direction (e.g., an X-axis direction or a column direction) from among the first electrodes 110 included in the plurality of unit cells UC. For example, the first electrodes 110 may include five first electrodes 110 continuously arranged in the first direction, and one first conductive line 140 may electrically connect the five first electrodes 110. A plurality of first electrodes electrically connected to one first conductive line may be referred to as a first electrode row 110a.

FIG. 1 shows five first electrode rows 110a and five first conductive lines 140. However, the embodiment is not limited thereto. The number of first electrode rows and first conductive lines may be designed differently depending on the use of the reconfigurable intelligent surface 100 and the like.

The plurality of first electrodes 110 and the plurality of first conductive lines 140 may be arranged on the same plane. For example, each of the first conductive lines 140 may include a plurality of first sub conductive lines 142 each electrically connecting two neighboring first electrodes 110 arranged in the first direction. The first electrodes 110 and the first sub conductive lines 142 may be alternately arranged in the first direction. That is, one end of the first sub conductive line 142 may contact a first electrode 110 included in a first unit cell UC among the plurality of unit cells UC, and the other end may contact a first electrode 110 included in a second unit cell UC that is arranged in the first direction and is adjacent to the first unit cell UC.

One first electrode row 110a and one first conductive line 140 may be integrally formed as a single body. Because one first electrode row 110a and one first conductive line 140 are integrally formed as a single body, the manufacturing is easy because a through hole or the like is not required. For example, one first electrode row 110a and one first conductive line 140 may be formed by one pattern process.

A width w₃ of the first sub conductive line 142 may be small so as not to affect the conversion of the operating wave. For example, the width w₃ of the first sub conductive line 142 may be less than a width w₁ of the first electrode 110. For example, the width w₃ of the first sub conductive line 142 may be less than or equal to ½, ¼, or ⅛ of the width w₁ of the first electrode 110. A length l₃ of the first sub conductive line 142 may correspond to the distance d₁ between the two first electrodes 110 arranged in the first direction. For example, the length l₃ of the first sub conductive line 142 may be less than or equal to about ¼ of the operating wavelength.

Alternatively, one first electrode row 110a may be connected to one first conductive line 140. For example, the plurality of first electrodes 110 may be formed after the formation of the plurality of first conductive lines 140 on a first substrate 160 to be described below.

The first conductive line 140 may include the same material as the first electrode 110, but is not limited thereto. The first conductive line 140 and the first electrode 110 may include different materials.

The reconfigurable intelligent surface 100 may further include a plurality of second conductive lines 150 electrically connecting second electrodes 120 arranged in the second direction (e.g., a Y-axis direction or a column direction) from among the second electrodes 120 included in the plurality of unit cells UC. For example, the second electrodes 120 may include five second electrodes 120 continuously arranged in the second direction, and one second conductive line 150 may electrically the five second electrodes 120. A plurality of second electrodes electrically connected to one second conductive line may be referred to as a second electrode column 120b.

FIG. 1 shows five second electrode columns 120b and five second conductive lines 150. However, the embodiment is not limited thereto. The number of second electrode columns and second conductive lines may be designed differently depending on the use of the reconfigurable intelligent surface 100 and the like.

The plurality of second electrodes 120 and the plurality of second conductive lines 150 may be arranged on the same plane. For example, each of the second conductive lines 150 may include a plurality of second sub conductive lines 152 each electrically connecting two neighboring second electrodes 120 arranged in the second direction. The second electrodes 120 and the second sub conductive lines 152 may be alternately arranged in the second direction. That is, one end of the second sub conductive line 152 may contact a second electrode 120 included in a third unit cell UC among the plurality of unit cells UC, and the other end may contact a second electrode 120 included in a fourth unit cell UC that is arranged in the second direction and is adjacent to the third unit cell UC.

The plurality of second electrodes 120 and the plurality of second conductive lines 150 may be integrally formed as a single body. Because the plurality of second electrodes 120 and the plurality of second conductive lines 150 may be formed in a single pattern process, the manufacturing may be easy. However, the embodiment is not limited thereto. The second electrodes 120 arranged in the second direction may be connected to one second conductive line 150.

A width w₄ of the second sub conductive line may be small so as not to affect the conversion of the operating wave. For example, the width w₄ of the second sub conductive line may be less than a width w₂ of the second electrode 120. For example, the width w₄ of the second sub conductive line may be less than or equal to ½, ¼, or ⅛ of the width w₂ of the second electrode 120. The length of the second sub conductive line may correspond to the distance d₂ between the two second electrodes 120 arranged in the second direction. For example, the length of the second sub conductive line may be less than or equal to about ¼ of the operating wavelength.

The second conductive line 150 may include the same material as the second electrode 120, but is not limited thereto. The second conductive line 150 and the second electrode 120 may include different materials.

The reconfigurable intelligent surface 100 may further include a first substrate 160 disposed on the upper surface of the first electrode 110 and a second substrate 170 disposed on the lower surface of the second electrode 120.

The first substrate 160 and the second substrate 170 may include an insulating material. For example, at least one of the first substrate 160 and the second substrate 170 may include glass, plastic, or the like. Alternatively, the first substrate 160 and the second substrate 170 may include silicon oxide, particularly quartz. The first substrate 160 and the second substrate 170 may respectively prevent the first electrode 110 and the second electrode 120 from being exposed to the outside, thereby protecting the first electrode 110 and the second electrode 120.

The reconfigurable intelligent surface 100 may further include a reflective layer 180 spaced apart from the second electrodes 120 included in the unit cells UC. The reflective layer 180 described above may be disposed on the lower surface of the second substrate 170. The distance between the second electrode 120 and the reflective layer 180, that is, the thickness of the second substrate 170, may be less than the operating wavelength. For example, the distance between the second electrode 120 and the reflective layer 180 may be less than or equal to ½ or ¼ of the operating wavelength. The reflective layer 180 may reflect waves incident on the reconfigurable intelligent surface 100 to the outside. The waves incident on the reconfigurable intelligent surface 100 are reflected by the second electrode 120, but reflection efficiency may be further increased by the reflective layer 180.

The reflective layer 180 has a plate shape and may include a conductive material. For example, the reflective layer 180 may include a metal having high electrical conductivity, such as copper.

The reflective layers 180 included in the plurality of unit cells UC may be formed as one layer on the second substrate 170. However, the embodiment is not limited thereto. A plurality of unit cells UC may be grouped to form one layer, and the grouped reflective layers may be spaced apart from each other. Also, the same voltage may be applied to the reflective layers 180. For example, one or more of the reflective layers 180 may be grounded. Because the reflective layer 180 is grounded, the reconfigurable intelligent surface 100 may operate stably.

In the reconfigurable intelligent surface 100 according to an embodiment, a bias voltage is applied to at least one of the first electrode 110 and the second electrode 120, and thus, the reconfigurable intelligent surface 100 may steer and reflect an incident wave in various directions. A bias voltage distribution simultaneously applied to the first electrodes 110 or the second electrodes 120 may be referred to as a bias voltage profile.

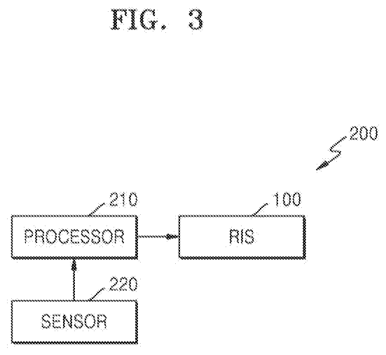

FIG. 3 is a block diagram illustrating an antenna device 200 including a reconfigurable intelligent surface 100 according to an embodiment. The antenna device 200 of FIG. 3 may be a base station in a wireless communication system. The antenna device 200 according to an embodiment may reflect an incident wave to a target area.

Referring to FIG. 3, the antenna device 200 may include a reconfigurable intelligent surface 100 and a processor 210. Because the reconfigurable intelligent surface 100 has been described above, a detailed description thereof will be omitted.

The processor 210 according to an embodiment may control the overall operation of the antenna device 200. For example, the processor 210 may control the reconfigurable intelligent surface 100 to steer an incident wave in a certain direction. The processor 210 may be electrically connected to the plurality of first conductive lines 140 and the plurality of second conductive lines 150. In addition, the processor 210 may apply a control signal to the reconfigurable intelligent surface 100 through the first conductive lines 140 and the second conductive lines 150. The control signal may be a quantized signal. For example, the control signal may be in the form of a DC voltage.

The processor 210 may perform protocol stack functions required by communication standards. To this end, the processor 210 may include a micro processor. Alternatively, the processor 210 may be referred to as a communication processor (CP).

The antenna device 200 may further include a sensor 220 for detecting a transmitter or a receiver. The transmitter may be a device for transmitting a wave incident on the reconfigurable intelligent surface 100, and the receiver may be a device for receiving a steered wave from the reconfigurable intelligent surface 100. The transmitter and the receiver may be a portable terminal, a base station, or the like. The sensor 220 may detect at least one of the transmitter and the receiver and deliver a result thereof to the processor 210. The sensor 220 may be disposed in an area of the reconfigurable intelligent surface 100. The processor 210 may control the reconfigurable intelligent surface 100 based on the positions of the transmitter, the receiver, and the like.

The antenna device 200 may include more or fewer components than those shown in FIG. 3.

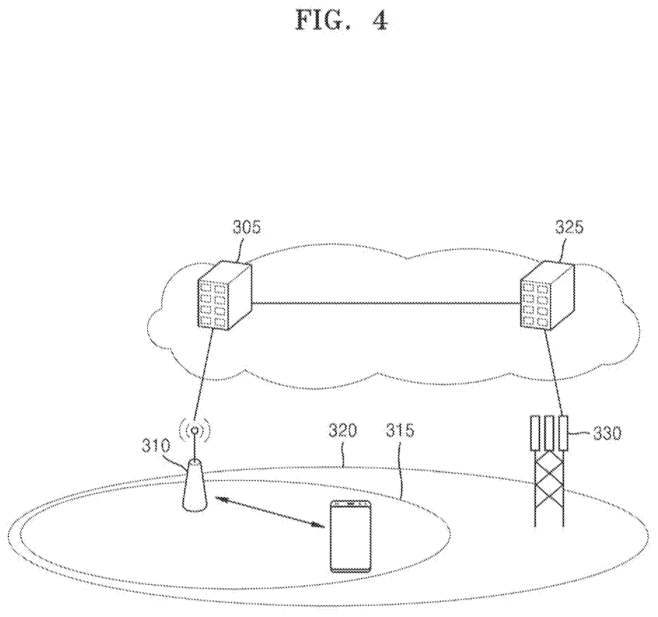

FIG. 4 is a diagram illustrating a communication system to which the reconfigurable intelligent surface 100 according to an embodiment is applied. For example, the communication system shown in FIG. 4 may be a 5G communication system. However, the disclosure is not limited thereto, and the descriptions of the communication system given with reference to FIG. 4 may also be applied to a next-generation communication system after the 5G communication system, that is, a 6G communication system. The communication system may include a network device 305, a first base station 310, a user terminal 315, a mobility management station 325, and a second base station 330.

The network device 305 may be connected to the first base station 310 and the mobility management station 325. The network device 305 may connect the user terminal 315 to a network of the communication system. The network device 305 may be in charge of various control functions of the user terminal 315. The network device 305 may enable the user terminal 315 to access the network. The network device 305 may support a mobility function of the user terminal 315. The mobility function may be a function that allows the user terminal 315 to freely move from one cell area 320 to another cell area. The network device 305 may support a quality of service (QoS) setting function of the user terminal 315. The network device 305 may determine priority order of transmitted information when the user terminal 315 transmits data, based on current resources, and may guarantee a specified level during data transmission.

The first base station 310 may be connected to the network device 305 and the user terminal 315. The first base station 310 may generate a cell area 320. The first base station 310 may connect the user terminal 315 within the cell area 320 to the network. The first base station 310 may establish a channel for the user terminal 315 to wirelessly access the network. The first base station 310 may control data transmission and reception of the user terminal 315 based on state information including available resources of the user terminal 315 and an environment of an established channel.

The mobility management station 325 may be connected to the network device 305 and the second base station 330. The mobility management station 325 may support a bearer setup function of the user terminal 315. When a bearer is established, it is possible to define how to process data of the user terminal 315 when passing through the network.

The second base station 330 may be connected to the mobility management station 325. The second base station 330 may provide a data bearer under the control of the mobility management station 325.

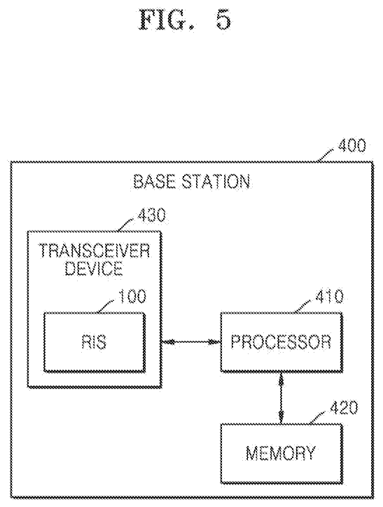

FIG. 5 is a block diagram of a base station 400 according to an embodiment. The base station 400 according to an embodiment may correspond to the first base station 310 described with reference to FIG. 4. That is, the base station 400 according to an embodiment may connect the user terminal 315 to a network of a communication system, and the network device 305 may be a device in charge of various control functions of the user terminal 315. The base station 400 may include a processor 410, a memory 420, and a transceiver device 430.

The processor 410 may control overall operations of the base station 400. The processor 410 may perform protocol stack functions required by communication standards. The processor 410 may perform baseband processing of transmitted and received signals and a backhaul communication function. The baseband processing may refer to a process of converting digital data into an RF signal to transmit signals through a Radio Access Network (RAN). The backhaul communication function may be a function of transmitting a signal from a remote location to another location. The processor 410 may store data in the memory 420. The processor 410 may load data stored in the memory 420.

The processor 410 may determine a channel type through which at least one piece of uplink control information is to be transmitted by executing a program stored in the memory 420. The processor 410 may provide setting information based on the determination result to a terminal and control the transceiver device 430 to receive at least one piece of uplink control information based on the setting information. The processor 410 may transmit setting information on whether an uplink control channel and an uplink data channel are simultaneously transmitted, and may control the transceiver device 430 to transmit scheduling information for at least one of at least one uplink control channel and at least one uplink data channel.

The memory 420 may store at least one program including a basic program for operation of the base station 400, an application program, and a setting program. The memory 420 may store information on a bearer allocated to a terminal connected to the base station 400 and at least one piece of terminal information including a measurement result reported from the connected terminal. The memory 420 may store determination information that is a criterion for determining whether to provide multiple connections to a terminal or to stop providing multiple connections. The memory 420 may store data according to a storage request of the processor 410. The memory 420 may provide stored data to the processor 410 according to a load request of the processor 410.

The transceiver device 430 may transmit/receive a signal to/from a terminal through a wireless channel. A transceiver 1702 may perform a conversion function between a baseband signal and digital data according to a physical layer standard of a communication system. When transmitting data, the transceiver device 430 may encode and modulate data to be transmitted. When receiving data, the transceiver device 430 may demodulate and decode the baseband signal. The transceiver device 430 may up-convert a baseband signal into an RF band signal and transmit the RF band signal through an antenna. The transceiver device 430 may down-convert an RF band signal received through the antenna into a baseband signal.

The transceiver device 430 may include a reconfigurable intelligent surface (RIS) 100. The reconfigurable intelligent surface 100 may set a channel environment for the transceiver device 430 to transmit or receive signals. The reconfigurable intelligent surface 100 may set a beam, which the transceiver device 430 generates to establish a channel. The reconfigurable intelligent surface 100 may adjust the direction of a beam for the transceiver to transmit or receive signals.

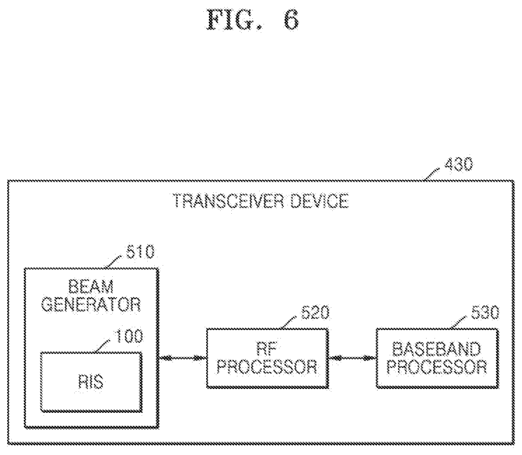

FIG. 6 is a block diagram of a transceiver device 430 according to an embodiment. The transceiver device 430 may include a beam generator 510, an RF processor 520, and a baseband processor 530.

The beam generator 510 may transmit and receive signals. The beam generator 510 may include an antenna for transmitting and receiving signals. The beam generator 510 may generate a beam for transmitting and receiving signals. The beam generator 510 may perform beamforming. The beam generator 510 may include a reconfigurable intelligent surface 100. The reconfigurable intelligent surface 100 may set a beam generated by the beam generator 510. The reconfigurable intelligent surface 100 may adjust the direction of the beam generated by the beam generator 510.

The RF processor 520 may perform a function for transmitting and receiving a signal through a wireless channel, such as a signal band conversion function and a signal amplification function. The RF processor 520 may up-convert a baseband signal to an RF band signal. The RF processor 520 may transmit an RF band signal through the beam generator 510. The RF processor 520 may down-convert the RF band signal received through the beam generator 510 into a baseband signal.

The baseband processor 530 may perform a conversion function between a baseband signal and digital data according to established physical layer standards of a wireless access technology. When transmitting data, the baseband processor 530 may encode and modulate digital data to be transmitted. When receiving data, the baseband processor 530 may convert a baseband signal provided from the RF processor 520 into digital data through demodulation and decoding.

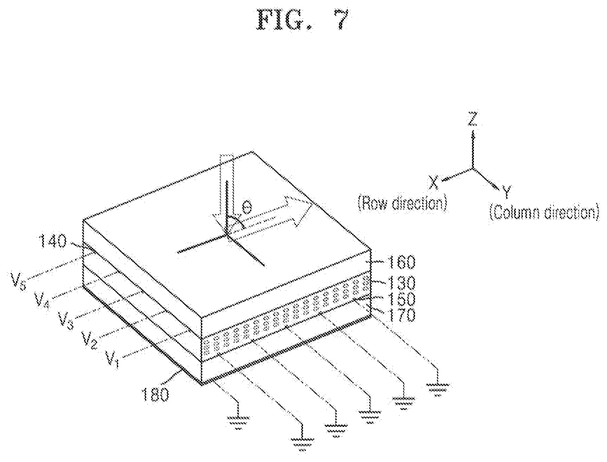

FIG. 7 is a reference diagram for explaining a method of steering a beam via the reconfigurable intelligent surface 100, according to a first embodiment. Referring to FIG. 7, the processor 210 may apply a bias voltage to each of the first electrodes 110 included in the reconfigurable intelligent surface 100 and may apply a ground voltage to the second electrodes 120. When a bias voltage is applied to each of the first electrodes 110, the same voltage may be applied to first electrodes 110 electrically connected to one first conductive line 140 from among the first electrodes 110. The first electrodes 110 electrically connected to one first conductive line 140 may be referred to as a first electrode row 110a.

For example, a first voltage V₁ may be applied to a 1+5(i−1)th (where i is a natural number) first electrode row 110a, a second voltage V₂ may be applied to a 2+5(i−1)th (where i is a natural number) first electrode row 110a, and a third voltage V₃ may be applied to a 3+5(i−1)th (where i is a natural number) first electrode row 110a. In addition, a fourth voltage V₄ may be applied to a 4+5(i−1)th (where i is a natural number) first electrode row 110a, and a fifth voltage V₅ may be applied to a 5+5(i−1)th (where i is a natural number) first electrode row 110a. The magnitude of the bias voltage and the bias voltage profile may vary depending on an angle to be steered.

Because the same voltage is applied to the first electrodes 110 included in the same first electrode row 110a, the unit cells UC arranged in the same row may have the same dielectric constant and the same impedance. On the other hand, the reconfigurable intelligent surface 100 may have a different dielectric constant distribution in a second direction (e.g., a Y-axis direction or a column direction). The distribution degree of the dielectric constant may vary based on the magnitude of the bias voltage and the bias voltage profile.

The reconfigurable intelligent surface 100 may steer an incident beam on a plane including the first direction. A steering angle may be adjusted by at least one of the magnitude of the bias voltage and the bias voltage profile and the cycle of the first electrode or the second electrode. For example, the beam steering angle may increase as the distance between electrodes decreases, and the beam steering angle may decrease as the distance between electrodes increases.

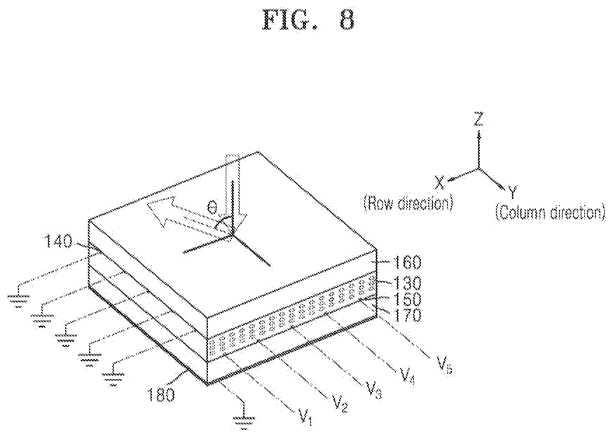

FIG. 8 is a reference diagram for explaining a method of steering a beam via the reconfigurable intelligent surface 100, according to a second embodiment. Referring to FIG. 8, the processor 210 may apply a bias voltage to the second electrodes 120 included in the reconfigurable intelligent surface 100 and may apply a ground voltage to the first electrodes 110. When a bias voltage is applied to the second electrodes 120, the same voltage may be applied to second electrodes 120 connected to one first conductive line 140 from among the second electrodes 120. That is, the same voltage may be applied to second electrodes 120 disposed in the same column. The second electrodes 120 disposed in the same column may be referred to as a second electrode column 120b.

For example, a first voltage V₁ may be applied to a 1+5(j−1)th (where j is a natural number) second electrode column 120b, a second voltage V₂ may be applied to a 2+5(j−1)th (where j is a natural number) second electrode column 120b, and a third voltage V₃ may be applied to a 3+5(j−1)th (where j is a natural number) second electrode column 120b. In addition, a fourth voltage V₄ may be applied to a 4+5(j−1)th (where j is a natural number) second electrode column 120b, and a fifth voltage V₅ may be applied to a 5+5(j−1)th (where j is a natural number) second electrode column 120b. The magnitude of the bias voltage and the bias voltage profile may vary depending on an angle to be steered.

Because the same voltage is applied to the second electrodes 120 included in the same second electrode column 120b, the unit cells UC arranged in the same column may have the same dielectric constant and the same impedance. On the other hand, the reconfigurable intelligent surface 100 may have a different dielectric constant distribution in a first direction (e.g., an X-axis direction or a row direction). The distribution degree of the dielectric constant may vary based on the magnitude of the bias voltage and the bias voltage profile. The reconfigurable intelligent surface 100 may steer an incident beam on a plane including the first direction. A steering angle may be adjusted by at least one of the magnitude of the bias voltage and the bias voltage profile. For example, the beam steering angle may increase as the distance between electrodes decreases, and the beam steering angle may decrease as the distance between electrodes increases.

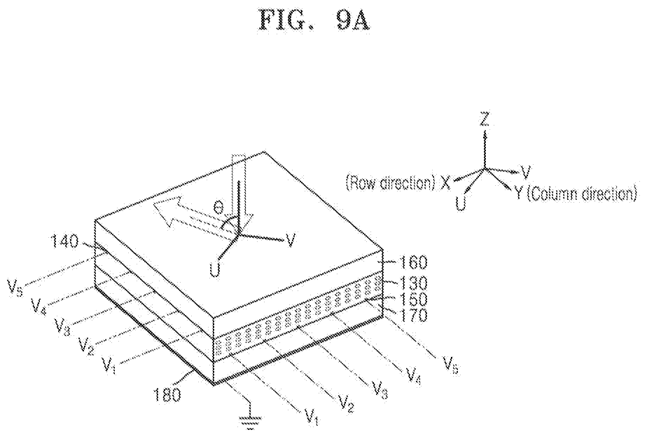

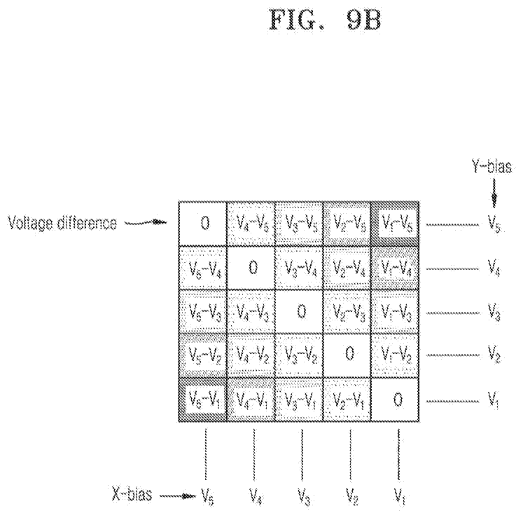

FIG. 9A is a reference diagram for explaining a method of steering a beam via the reconfigurable intelligent surface 100, according to a third embodiment. FIG. 9B is a diagram showing an example of a voltage distribution of a unit cell UC in the reconfigurable intelligent surface 100 according to an embodiment. Referring to FIG. 9A, the processor 210 may apply a bias voltage to the first electrodes 110 and the second electrodes 120 such that the same voltage is applied to unit cells UC arranged in a third direction (e.g., a U-axis direction) crossing both a first direction (e.g., an X-axis direction or a row direction) and a second direction (e.g., a Y-axis direction or a column direction) from among the plurality of unit cells UC.

For example, a first voltage V₁ may be applied to a 1+5(i−1)th (where i is a natural number) first electrode row 110a, a second voltage V₂ may be applied to a 2+5(i−1)th (where i is a natural number) first electrode row 110a, and a third voltage V₃ may be applied to a 3+5(i−1)th (where i is a natural number) first electrode row 110a. In addition, a fourth voltage V₄ may be applied to a 4+5(i−1)th (where i is a natural number) first electrode row 110a, and a fifth voltage V₅ may be applied to a 5+5(i−1)th (where i is a natural number) first electrode row 110a.

Furthermore, the first voltage V₁ may be applied to a 1+5(j−1)th (where j is a natural number) second electrode column 120b, the second voltage V₂ may be applied to a 2+5(j−1)th (where j is a natural number) second electrode column 120b, and the third voltage V₃ may be applied to a 3+5(j−1)th (where j is a natural number) second electrode column 120b. In addition, the fourth voltage V₄ may be applied to a 4+5(j−1)th (where j is a natural number) second electrode column 120b, and the fifth voltage V₅ may be applied to a 5+5(j−1)th (where j is a natural number) second electrode column 120b.

Because the same voltage is applied to unit cells UC arranged in the third direction (e.g., the U-axis direction) crossing both the first direction (e.g., the X-axis direction or the row direction) and the second direction (e.g., the Y-axis direction or the column direction) from among the plurality of unit cells UC, the unit cells UC arranged in the third direction (e.g., the U-axis direction) may have the same dielectric constant and thus have the same impedance. Also, the dielectric constant may vary in a fourth direction (e.g., a V-axis direction) perpendicular to the third direction (e.g., the U-axis direction). Thus, an incident beam may be steered on a plane including the fourth direction (e.g., the V-axis direction). A steering angle may be adjusted by the magnitude of the bias voltage and the bias voltage profile.

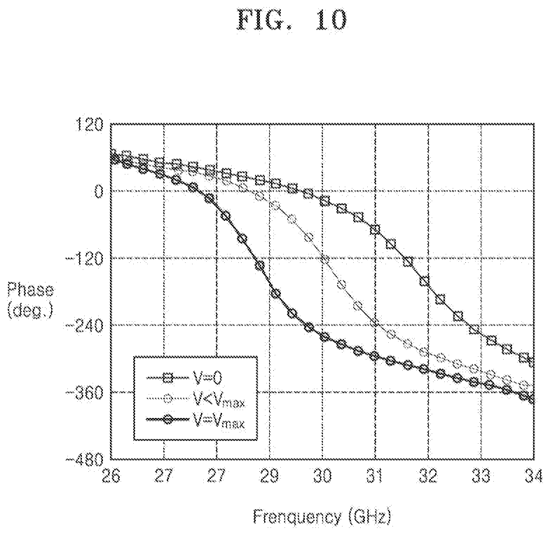

FIG. 10 is a result showing a phase shift according to an operating frequency of a unit cell UC included in the reconfigurable intelligent surface 100 according to an embodiment. Referring to FIG. 10, when the liquid crystal molecules of the liquid crystal layer 130 are arranged in a direction parallel to the surface of the second electrode 120, that is, when no voltage is applied to the unit cell UC, when a wave of about 30 GHz is incident, a phase shift of about −20 degrees occurs.

In addition, when the liquid crystal molecules of the liquid crystal layer 130 are arranged in a direction perpendicular to the surface of the second electrode 120, that is, when a maximum voltage is applied to the unit cell UC, when a wave of about 30 GHz is incident, a phase shift of about −260 degrees occurs.

When the liquid crystal molecules of the liquid crystal layer 130 are arranged in an inclined direction with respect to the surface of the second electrode 120, that is, when a voltage equal to or less than the maximum voltage is applied to the unit cell UC, when a wave of about 30 GHz is incident, a wave with a phase shift of about −120 degrees is output.

Accordingly, it may be confirmed that the reconfigurable intelligent surface 100 according to an embodiment may change the phase within a range of about 250 degrees for a wave having an operating frequency of about 30 GHz.

The reconfigurable intelligent surface 100 according to an embodiment may steer a wave over a wide angle. The frequency band width w of a wave having a variable phase range of about 100 degrees or more may be about 4 GHz. For example, a wave with an operating frequency of about 29 GHz to about 34 GHz may have a variable phase range of about 100 degrees or more.

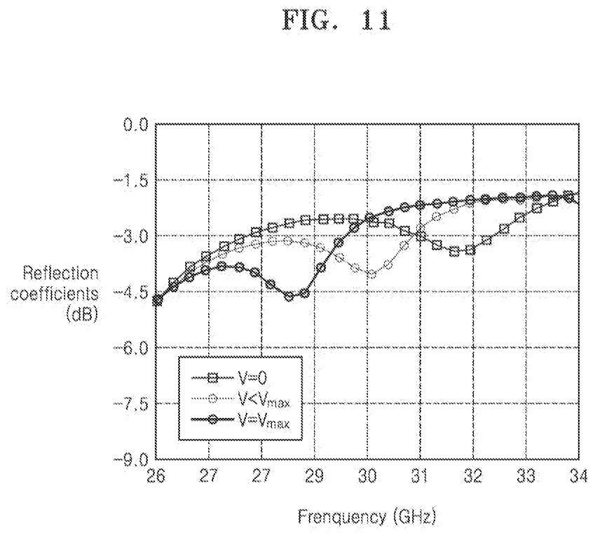

FIG. 11 is a graph showing reflection loss according to an operating frequency of a unit cell UC according to an embodiment. Referring to FIG. 11, when the liquid crystal molecules of the liquid crystal layer 130 are arranged in a direction parallel to the surface of the second electrode 120, that is, when no voltage is applied to the unit cell UC, the reflection loss for a wave of about 30 GHz is about −2.6 dB.

In addition, when the liquid crystal molecules of the liquid crystal layer 130 are arranged in a direction perpendicular to the surface of the second electrode 120, that is, when the maximum voltage is applied to the unit cell UC, the reflection loss for a wave of about 30 GHz is about −2.2 dB.

When the liquid crystal molecules of the liquid crystal layer 130 are arranged in an inclined direction with respect to the surface of the second electrode 120, that is, when a voltage equal to or less than the maximum voltage is applied to the unit cell UC, the reflection loss for a wave of about 30 GHz is about −4 dB.

Accordingly, it may be confirmed that the reconfigurable intelligent surface 100 according to an embodiment has a reflection loss value of −5 dB or less for a wave having an operating frequency of about 26 GHz to about 36 GHz.

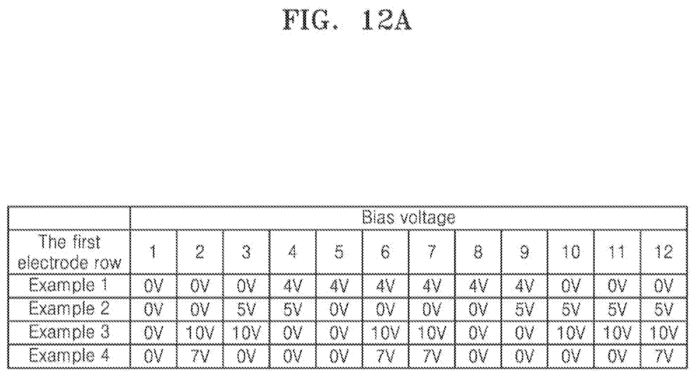

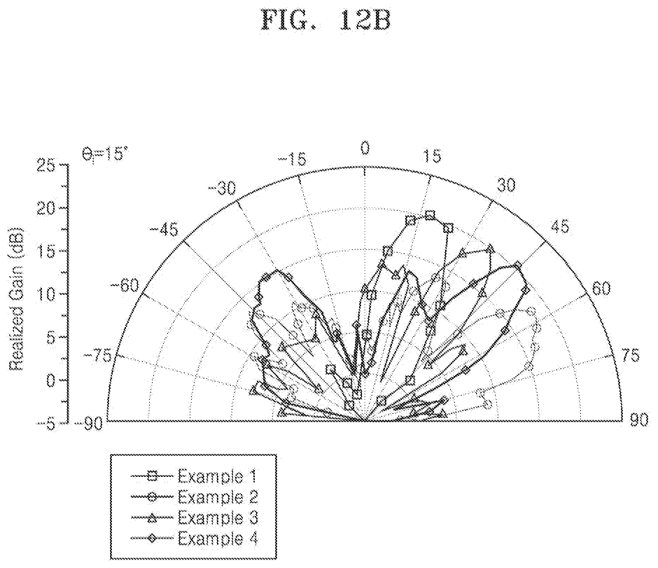

FIG. 12A shows a profile of a bias voltage applied to the first electrode row 110a of the reconfigurable intelligent surface 100 according to an embodiment, and FIG. 12B shows a result of measuring the reflection gain of the reconfigurable intelligent surface 100 based on the bias voltage profile of FIG. 12A.

As shown in FIG. 12A, a quantized bias voltage of 1 bit may be applied to the first electrodes 110 of the reconfigurable intelligent surface 100, and the second electrode 120 thereof may be grounded.

Referring to FIGS. 12A and 12B, when a wave of about 29.5 GHz is incident on the reconfigurable intelligent surface 100 in a state in which a bias voltage profile according to Example 1 is applied to the first electrode row 110a, the incident wave is steered at about 15 degrees and reflected. Here, the wave may be perpendicularly incident on the reconfigurable intelligent surface 100.

When a wave of about 29.5 GHz is incident on the reconfigurable intelligent surface 100 in a state in which a bias voltage profile according to Example 2 is applied to the first electrode row 110a, the incident wave is steered at about 33 degrees and reflected.

When a wave of about 29.5 GHz is incident on the reconfigurable intelligent surface 100 in a state in which a bias voltage profile according to Example 3 is applied to the first electrode row 110a, the incident wave is steered at about 48 degrees and reflected.

When a wave of about 29.5 GHz is incident on the reconfigurable intelligent surface 100 in a state in which a bias voltage profile according to Example 4 is applied to the first electrode row 110a, the incident wave is steered at about 62 degrees and reflected.

It may be confirmed that the steering angle of the incident wave is changed according to the magnitude of the bias voltage and the bias voltage profile. Although it is assumed, in FIG. 9A, that a bias voltage quantized by 1 bit is applied to the reconfigurable intelligent surface 100, but the embodiment is not limited thereto. The bias voltage may be multi-bit quantized.

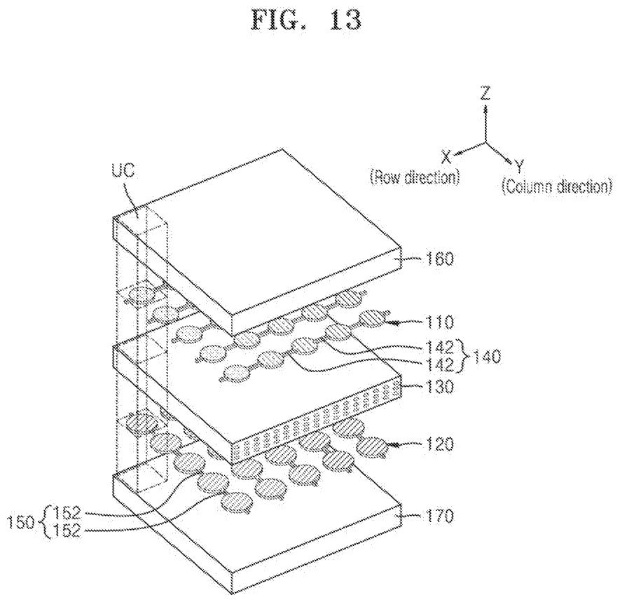

FIG. 13 is a diagram illustrating a reconfigurable intelligent surface 101 according to another embodiment. Comparing FIG. 1 with FIG. 13, the reconfigurable intelligent surface 101 of FIG. 13 may not include the reflective layer 180 of FIG. 1. In the reconfigurable intelligent surface 101 of FIG. 13, a second electrode 120 may perform a reflective function. In order to increase the reflection efficiency of the reconfigurable intelligent surface 101, the distance between second electrodes 120 may be less than or equal to ⅛ of an operating wavelength.

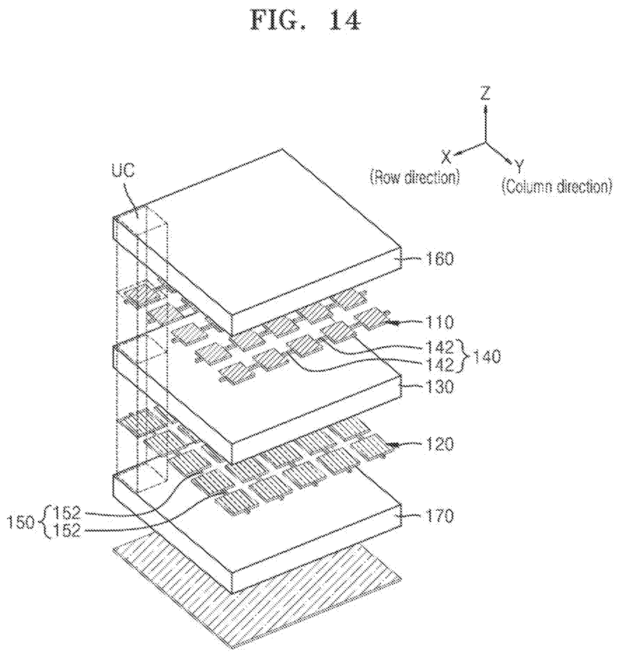

FIG. 14 is a diagram illustrating a reconfigurable intelligent surface 102 according to another embodiment. Comparing FIG. 1 with FIG. 14, the reconfigurable intelligent surface 102 of FIG. 14 may include a first electrode 110 and a second electrode 120 in a rectangular shape. When the first electrode 110 and the second electrode 120 have a rectangular shape, a region of the second electrode 120 that does not overlap the first electrode 110 may be slightly larger than the curved electrodes of FIG. 1. However, the reconfigurable intelligent surface 102 of FIG. 14 has the advantage of being easier to manufacture than the reconfigurable intelligent surface 100 of FIG. 1.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A transceiver comprising:
a beam generator configured to generate a beam for transmitting and receiving a radio frequency (RF) band signal;
an RF processor configured to up-convert a baseband signal into the RF band signal and transmit the RF band signal through the beam generator, or down-convert the RF band signal received through the beam generator into the baseband signal; and
a baseband processor configured to perform a conversion function between the baseband signal and digital data,
wherein the beam generator includes:
an antenna configured to transmit and receive the RF band signal; and
a reconfigurable intelligent surface configured to adjust a direction of the beam,
wherein the reconfigurable intelligent surface is further configured to adjust the direction of the beam based on bias voltage distribution of a plurality of unit cells arranged in a matrix type.

2. The transceiver of claim 1, wherein each of the plurality of unit cells includes:
a first electrode;
a second electrode spaced apart from the first electrode; and
a liquid crystal layer disposed between the first electrode and the second electrode.

3. The transceiver of claim 2, wherein an outer circumferential surface of at least one of the first electrode and the second electrode includes a curved line.

4. The transceiver of claim 2, further comprising:
a first conductive line disposed in a first direction and electrically connecting the first electrodes respectively included in the plurality of unit cells; and
a second conductive line disposed in a second direction perpendicular to the first direction and electrically connecting the second electrodes respectively included in the plurality of unit cells.

5. The transceiver of claim 2, wherein the liquid crystal layer has a dielectric constant that changes according to an applied electric field based on the bias voltage distribution.

6. The transceiver of claim 2, wherein the direction of the beam is adjusted based on an interval between at least one of the first electrode and the second electrode included in each of the plurality of unit cells.

7. The transceiver of claim 2, wherein a bias voltage is applied to one of the first electrode and the second electrode, and a ground voltage is applied to the other of the first electrode and the second electrode.

8. A reconfigurable intelligent surface comprising:
a plurality of unit cells arranged in a first direction and a second direction perpendicular to the first direction, each of the plurality of unit cells including a first electrode, a liquid crystal layer, and a second electrode;
a plurality of first conductive lines electrically connecting to each other first electrodes arranged in the first direction from among the first electrodes included in the plurality of unit cells; and
a plurality of second conductive lines electrically connecting to each other second electrodes arranged in the second direction from among the second electrodes included in the plurality of unit cells,
wherein a wave incident on the reconfigurable intelligent surface is steered in a certain direction based on an electrical signal applied to the plurality of unit cells.

9. The reconfigurable intelligent surface of claim 8, wherein a cross-sectional size of the second electrode is greater than or equal to a cross-sectional size of the first electrode.

10. The reconfigurable intelligent surface of claim 8, wherein an outer circumferential surface of at least one of the first electrode and the second electrode is curved.

11. The reconfigurable intelligent surface of claim 8, wherein the first electrode is entirely disposed to overlap the second electrode in a thickness direction of the liquid crystal layer.

12. The reconfigurable intelligent surface of claim 8, wherein lengths of the first electrode and the second electrode are less than or equal to ½ of a wavelength of the wave.

13. The reconfigurable intelligent surface of claim 8, wherein a distance between second electrodes included in adjacently arranged unit cells among the plurality of unit cells is less than or equal to ¼ of a wavelength of the wave.

14. The reconfigurable intelligent surface of claim 8, wherein the plurality of first conductive lines are arranged on a same plane as the first electrodes included in the plurality of unit cells.

15. The reconfigurable intelligent surface of claim 8, wherein at least one of the plurality of first conductive lines includes a plurality of first sub conductive lines spaced apart from each other in the first direction and connecting to each other two unit cells arranged adjacently in the first direction.

16. The reconfigurable intelligent surface of claim 15, wherein widths and lengths of the plurality of first sub conductive lines are less than a width and a length of the first electrode, respectively.

17. The reconfigurable intelligent surface of claim 8, further comprising a reflective layer spaced apart from the plurality of unit cells and reflecting waves incident from the plurality of unit cells to the plurality of unit cells.

18. The reconfigurable intelligent surface of claim 8, wherein, when a bias voltage is applied to the first electrodes included in the plurality of unit cells and the second electrodes included in the plurality of unit cells are grounded, the wave is steered on a plane including the second direction.

19. The reconfigurable intelligent surface of claim 8, wherein, when the first electrodes included in the plurality of unit cells are grounded and a bias voltage is applied to the second electrodes included in the plurality of unit cells, the wave is steered on a plane including the first direction.

20. The reconfigurable intelligent surface of claim 8, wherein, when a bias voltage is applied to the first electrodes and the second electrodes such that a same voltage is applied to unit cells arranged in a third direction crossing both the first direction and the second direction from among the plurality of unit cells, the wave is steered on a plane including the fourth direction perpendicular to the third direction.
